(19) United States
(12) Patent Application Publication
(10) Pub. No.: US 2003/0216280 A1
(43) Pub. Date: Nov. 20, 2003

(54) Fabric conditioning composition comprising agent for enhancing the appearance of the rinse solution

(75) Inventors: Vera Maria Martens, Andenne (BE); Frederic Bernard Robin, Ixelles (BE); Victor Javier Aguilar Moses, Waterloo (BE); Jean-Lue Philippe Bettiol, Brussels (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/439,551

(22) Filed: May 16, 2003

Related U.S. Application Data
(60) Provisional application No. 60/381,403, filed on May 16, 2002.

(51) Int. Cl. C11D 3/00; D06L 1/00

(52) U.S. Cl. 510/466; 510/375; 510/504; 510/515

(57) ABSTRACT

A liquid rinse added fabric conditioning composition having a fabric softening compound; an effective amount of a appearance enhancing agent selected from the group consisting of a peroxygen bleaching agent, a bluing agent, and mixtures thereof, and the balance adjunct ingredients. The conditioning compositions improving the color and/or clarity of a rinse solution containing laundered fabric while simultaneously providing a softening benefit to the fabrics. The compositions are particularly advantageous when laundering fabrics by hand.

### CROSS REFERENCE TO RELATED APPLICATIONS

This application claims the benefit under 35 U.S.C. § 119(e) of U.S. Provisional Application Serial No. 60/381,403, filed May 16, 2002 (Attorney Docket No.8918P).

### FIELD OF INVENTION

The present invention relates to liquid rinse-added fabric conditioning compositions and more specifically, fabric softening compositions, and uses and methods for improving the color and/or clarity of a fabric rinse solution comprising a fabric softening composition.

### BACKGROUND OF THE INVENTION

U.S. Pat. No. 4,045,358 issued Aug. 30, 1977 to Ramachandran, teaches a softening and bleaching composition that comprises a quaternary ammonium softener and a perphthalic acid within a stated ratio. The composition is described as a non-yellowing fabric softener composition.

U.S. Pat. No. 4,166,794 issued Sep. 4, 1979 to Grey, teaches a liquid bleach softener comprising a water-soluble peroxy bleaching agent and a water-soluble cationic nitrogen softener compound wherein the ratio of the softener to peroxy bleaching agent is 5:7 to 5:1.

U.S. Pat. No. 4,203,852 issued May 20, 1980 to Johnson et al., teaches a softener bleach in granule, powder, pellet or bead form for dispensing in the wash cycle with an organic detergent.

U.S. Pat. No. 4,273,661 issued Jun. 16, 1981 to Grey, teaches a foam article for dispensing a liquid bleach softener comprising a water-soluble peroxy bleaching agent and a water-soluble cationic nitrogen softener compound wherein the ratio of the softener to peroxy bleaching agent is 5:7 to 5:1.

U.S. Pat. No. 4,460,487 issued Jul. 17, 1984 to Robinson et al. teaches a fabric bleaching and softening composition comprising a hydrogen peroxide and a cationic amine softener wherein the ratio of softener to hydrogen peroxide is from about 1:20 to about 2:3.

U.S. Pat. No. 5,077,119 issued Dec. 31, 1991 to Wraige, teaches a fabric conditioning article comprising a substrate comprising two separate areas with softening material substantially free of peroxy bleach located in a first area, and a peroxy bleach substantially free of softening material located in a second area.

### SUMMARY OF THE INVENTION

The present invention provides liquid rinse added fabric conditioning compositions comprising, a fabric softening compound, an effective amount of a appearance enhancing agent to improve the clarity and/or color of the rinse solution, and the balance adjunct ingredients. The appearance enhancing agent is a peroxygen bleaching agent, a bluing agent, or mixture thereof. Preferably, the fabric softening compound is an alkyl organic compound or a silicone softening emulsion. More preferably, the fabric softening compound is a quaternary ammonium compound having at least one C₁₂-C₂₂ hydrocarbyl chain that is unsaturated and or that is interrupted by an ester group.

When the appearance enhancing agent is a peroxygen bleaching agent, the weight ratio of the fabric softening compound to the peroxygen bleaching agent is between about 2:1 and about 1:4, providing that when the ratio is between 1:1 and 1:4 the peroxygen bleaching agent is not a perphthalic acid or derivative thereof and further providing that when the ratio is between 1:1.5 and 1:4 the composition comprises greater than 6% of the fabric softening compound. Preferably, the peroxygen bleaching agent is present in the fabric conditioning composition at a level less than about 15% by weight of the composition.

When the appearance enhancing agent is a bluing agent, the bluing agent is at a level between about 0.004% and about 0.1% by weight of the composition. Where the appearance enhancing agent is a mixture of a peroxygen bleaching agent and bluing agent, the bluing agent is preferably stable in the presence of the peroxygen bleaching agent.

The present invention further provides for the use of a bleaching agent in a liquid rinse-added fabric conditioning composition to improve the color and/or clarity of the rinse solution. Similarly, the invention provides for the use of a bluing agent in a liquid rinse-added fabric conditioning composition to improve the color and/or clarity of the rinse solution.

In a process aspect, the present invention provides methods for improving the color and/or clarity of a laundry rinse solution, the methods comprising the steps of washing fabrics in an aqueous detergent solution, rinsing the fabrics in an aqueous rinse solution, and adding a liquid fabric conditioning composition of the present invention to the rinse solution. The fabric conditioning composition comprising an effective amount of a appearance enhancing agent selected from the group consisting of peroxygen bleaching agent, a bluing agent, or mixtures thereof. Preferably, the methods relate to improving the color and/or clarity of a rinse solution that is used to rinse fabrics by hand.

The present invention further provides for fabric conditioning products that include a liquid fabric conditioning composition according to the present invention, a container for the composition, and a set of instructions associated with the container, said set of instructions comprising an instruction to a consumer to use the fabric conditioning composition to improve the color and/or clarity of the rinse solution. Preferably, the set of instructions includes an instruction to use the fabric conditioning composition when rinsing fabrics by hand.

All documents cited are, in relevant part, incorporated herein by reference; the citation of any document is not to be construed as an admission that it is prior art with respect to the present invention.

### DETAILED DESCRIPTION OF THE INVENTION

I. Fabric Conditioning Composition

A. Fabric Softening Compound

Typical levels of incorporation of the softening compound in the conditioning composition are of from 1% to 90%, preferably from 2% to 70%, and even more preferably from 5% to 40%, by weight of the composition. Preferably, the fabric softening compound is an alkyl organic compound or a silicone softening emulsion. The softening compounds can be selected from cationic, nonionic, and/or amphoteric compounds. Any conventional fabric softening compound may be used to advantage in the compositions of the present invention.

Typical of the cationic softening compounds are the quaternary ammonium compounds or amine precursors thereof as defined hereinafter. The fabric softener compound preferably has a phase transition temperature of less than about 55° C. Where a clear fabric conditioning composition is desired, it is preferred that the fabric softener compound have a phase transition temperature of less than 50° C., more preferably less than about 35° C., even more preferably less than about 20° C., and yet even more preferably less than about 0° C., and preferably is biodegradable as disclosed hereinafter. Likewise, where a clear composition is desired, the IV is preferably from about 40 to about 140, preferably from about 50 to about 120 and even more preferably from about 85 to about 105. When an unclear composition is desired, the IV may be below 40.

Fabric softening compounds useful in the conditioning compositions of the present invention can be selected from:

1. Softeners having the formula:

[R₄₋ₘ−N⁽⁺⁾−R¹ₘ]A⁻

wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and where the Iodine Value (hereinafter referred to as “IV”) of a fatty acid containing this R¹ group is from about 70 to about 140, more preferably from about 80 to about 130; and most preferably from about 90 to about 115 (as used herein, the term “Iodine Value” means the Iodine Value of a “parent” fatty acid, or “corresponding” fatty acid, which is used to define a level of unsaturation for an R¹ group that is the same as the level of unsaturation that would be present in a fatty acid containing the same R¹ group) with, preferably, a cis/trans ratio of from about 1:1 to about 50:1, the minimum being 1:1, preferably from about 2:1 to about 40:1, more preferably from about 3:1 to about 30:1, and even more preferably from about 4:1 to about 20:1; each R¹ can also preferably be a branched chain C₁₄-C₂₂ alkyl group, preferably a branched chain C₁₆-C₁₈ group; each R is H or a short chain C₁-C₆, preferably C₁-C₃ alkyl or hydroxyalkyl group, e.g., methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, and nitrate, more preferably chloride and methyl sulfate;

2. Softeners having the formula:

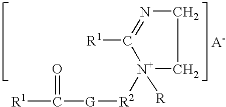

wherein each R, R¹, and A⁻ have the definitions given above; each R² is a C₁₋₆ alkylene group, preferably an ethylene group; and G is an oxygen atom or an —NR-group;

3. Softeners having the formula:

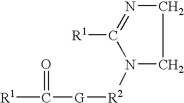

wherein R¹, R² and G are defined as above;

4. Reaction products of substantially unsaturated and/or branched chain higher fatty acids with dialkylenetriamines in, e.g., a molecular ratio of about 2:1, said reaction products containing compounds of the formula:

R¹—C(O)—NH—R²—NH—R³—NH—C(O)—R¹

wherein R¹, R² are defined as above, and each R³ is a C₁₋₆ alkylene group, preferably an ethylene group;

5. Softeners having the formula:

[R¹—C(O)—NR—R²—N(R)₂—R³—NR—C(O)—R¹]⁺A⁻

wherein R, R¹, R², R³ and A⁻ are defined as above;

6. Reaction products of substantially unsaturated and/or branched chain higher fatty acid with hydroxyalkylalkylenediamines in a molecular ratio of about 2:1, said reaction products containing compounds of the formula:

R¹—C(O)—NH—R²—N(R³OH)—C(O)—R¹

wherein R¹, R² and R³ are defined as above;

7. Softener having the formula:

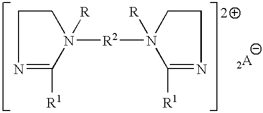

wherein R, R¹, R², and A⁻ are defined as above.

Other optional but highly desirable cationic compounds which can be used in combination with the above softener actives are compounds containing one long chain acyclic C₈-C₂₂ hydrocarbon group, selected from the group consisting of:

8. Acyclic quaternary ammonium salts having the formula:

[R¹—N(R⁵)₂—R⁶]⁺A⁻

wherein R⁵ and R⁶ are C₁-C₄ alkyl or hydroxyalkyl groups, and R¹ and A⁻ are defined as herein above;

9. Substituted imidazolinium salts having the formula:

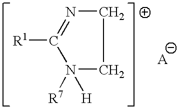

wherein R⁷ is hydrogen or a C₁-C₄ saturated alkyl or hydroxyalkyl group, and R¹ and A⁻ are defined as hereinabove;

10. substituted imidazolinium salts having the formula:

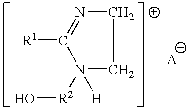

wherein R⁵ is a C₁-C₄ alkyl or hydroxyalkyl group, and R¹, R², and A⁻ are as defined above;

11. Alkylpyridinium salts having the formula:

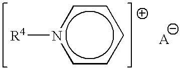

wherein R⁴ is an acyclic aliphatic C₈-C₂₂ hydrocarbon group and A⁻ is an anion; and

12. Alkanamide alkylene pyridinium salts having the formula:

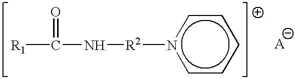

wherein R¹, R² and A⁻ are defined as herein above; and mixtures thereof.

Examples of Compound 1. are dialkylenedimethylammonium salts such as dicanoladimethylammonium chloride, dicanoladimethylammonium methylsulfate, di(partially hydrogenated soybean, cis/trans ratio of about 4:1)dimethylammonium chloride, dioleyldimethylammonium chloride. Dioleyldimethylammonium chloride and di(canola)dimethylammonium chloride are preferred. An example of commercially available dialkylenedimethylammonium salts usable in the present invention is dioleyldimethylammonium chloride available from Witco Corporation under the trade name Adogen® 472.

An example of Compound 2. is 1-methyl-1-oleylamidoethyl-2-oleylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Witco Corporation under the trade name Varisoft® 3690.

An example of Compound 3. is 1-oleylamidoethyl-2-oleylimidazoline wherein R¹ is an acyclic aliphatic C₁₅-C₁₇ hydrocarbon group, R² is an ethylene group, and G is a NH group.

An example of Compound 4. is reaction products of oleic acids with diethylenetriamine in a molecular ratio of about 2:1, said reaction product mixture containing N,N″-dioleoyldiethylenetriamine with the formula:

R¹—C(O)—NH—CH₂CH₂—NH—CH₂CH₂—NH—C(O)—R¹

wherein R¹—C(O) is oleoyl group of a commercially available oleic acid derived from a vegetable or animal source, such as Emersol® 223LL or Emersol® 7021, available from Henkel Corporation, and R² and R³ are divalent ethylene groups.

An example of Compound 5. is a difatty amidoamine based softener having the formula:

[R¹—C(O)—NH—CH₂CH₂—N(CH₃)(CH₂CH₂OH)—CH₂CH₂—NH—C(O)—R¹]⁺CH₃SO₄⁻

wherein R¹—C(O) is oleoyl group, available commercially from the Witco Corporation under the trade name Varisoft® 222LT.

An example of Compound 6. is reaction products of oleic acids with N-2-hydroxyethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is oleoyl group of a commercially available oleic acid derived from a vegetable or animal source, such as Emersol® 223LL or Emersol® 7021, available from Henkel Corporation.

An example of Compound 7. is the diquaternary compound having the formula:

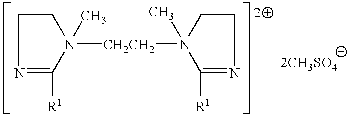

wherein R¹ is derived from oleic acid, and the compound is available from Witco Company.

Examples of Compound 8. are the monoalkenyltrimethylammonium salts such as monooleyltrimethylammonium chloride, monocanolatrimethylammonium chloride, and soyatrimethylammonium chloride. Monooleyltrimethylammonium chloride and monocanolatrimethylammonium chloride are preferred. Other examples of Compound 8. are soyatrimethylammonium chloride available from Witco Corporation under the trade name Adogen® 415, erucyltrimethylammonium chloride wherein R¹ is a C₂₂ hydrocarbon group derived from a natural source; soyadimethylethylammonium ethylsulfate wherein R¹ is a C₁₆-C₁₈ hydrocarbon group, R⁵ is a methyl group, R⁶ is an ethyl group, and A⁻ is an ethylsulfate anion; and methyl bis(2-hydroxyethyl)oleylammonium chloride wherein R¹ is a C₁₈ hydrocarbon group, R⁵ is a 2-hydroxyethyl group and R⁶ is a methyl group.

An example of Compound 11. is 1-ethyl-1-(2-hydroxyethyl)-2-isoheptadecyl-imidazolinium ethylsulfate wherein R¹ is a C₁₇ hydrocarbon group, R² is an ethylene group, R⁵ is an ethyl group, and A⁻ is an ethylsulfate anion.

Additional fabric softeners that can be used herein are disclosed, at least generically for the basic structures, in U.S. Pat. Nos. 3,861,870, Edwards and Diehl; 4,308,151, Cambre; 3,886,075, Bernardino; 4,233,164, Davis; 4,401,578, Verbruggen; 3,974,076, Wiersema and Rieke; and 4,237,016, Rudkin, Clint, and Young, all of said patents being incorporated herein by reference. The additional softener actives herein are preferably those that are highly unsaturated versions of the traditional softener actives, i.e., di-long chain alkyl nitrogen derivatives, normally cationic materials, such as dioleyldimethylammonium chloride and imidazolinium compounds as described hereinafter. Examples of more biodegradable fabric softeners can be found in U.S. Pat. Nos. 3,408,361, Mannheimer, issued Oct. 29, 1968; 4,709,045, Kubo et al., issued Nov. 24, 1987; 4,233,451, Pracht et al., issued Nov. 11, 1980; 4,127,489, Pracht et al., issued Nov.28, 1979; 3,689,424, Berg et al., issued Sep. 5, 1972; 4,128,485, Baumann et al., issued Dec. 5, 1978; 4,161,604, Elster et al., issued Jul. 17, 1979; 4,189,593, Wechsler et al., issued Feb. 19, 1980; and 4,339,391, Hoffman et al., issued Jul. 13, 1982, said patents being incorporated herein by reference.

In addition, silicones such as emulsions of cationic amine functional polymer, nonionic dimethicone copolymer and mixtures the same, can be used as the softening compound or component. Preferred emulsions comprise amodimethicone (and) trideceth-12 (and) cetrimonium chloride cationic co-polymer and/or Divinyldimethicone/Dimethicone Copolymer (and) C12-C13 Pareth-3 (and) C12-C13 Pareth-23.

Particularly preferred softening compounds include quaternary ammonium compounds, including various diester and polyquaternary compounds.

A first type of DEQA preferably comprises, as the principal active, [DEQA (1)] compounds of the formula

{R₄₋ₘ—N⁺—[(CH₂)ₙ—Y—R¹]ₘ}X⁻

wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group, and X⁻ can be any softener-compatible anion, preferably, chloride, bromide, methylsulfate, ethylsulfate, sulfate, and nitrate, more preferably chloride or methyl sulfate (As used herein, the “percent of softener active” containing a given R¹ group is based upon taking a percentage of the total active based upon the percentage that the given R¹ group is, of the total R¹ groups present.);

A second type of DEQA active [DEQA (2)] has the general formula:

[R₃N⁺CH₂CH(YR¹ )(CH₂YR¹)]X⁻

wherein each Y, R, R¹, and X⁻ have the same meanings as before. Such compounds include those having the formula:

[CH₃]₃N⁽⁺⁾[CH₂CH(CH₂O(O)CR¹)O(O)CR¹]Cl⁽⁻⁾

wherein each R is a methyl or ethyl group and preferably each R¹ is in the range of C₁₅ to C₁₉. As used herein, when the diester is specified, it can include the monoester that is present. The amount of monoester that can be present is the same as in DEQA (1).

These types of agents and general methods of making them are disclosed in U.S. Pat. No. 4,137,180, Naik et al., issued Jan. 30, 1979, which is incorporated herein by reference. An example of a preferred DEQA (2) is the “propyl” ester quaternary ammonium fabric softener active having the formula 1,2-di(acyloxy)-3-trimethylammoniopropane chloride, where the acyl is the same as that of FA¹ disclosed hereinafter.

Some preferred clear fabric conditioning compositions contain as an essential component from about 2% to about 75%, preferably from about 8% to about 70%, more preferably from about 13% to about 65%, and even more preferably from about 18% to about 45% by weight of the composition, of softener active having the formula:

[R¹C(O)OC₂H₄]ₘN⁺(R)₄₋ₘX⁻

wherein each R¹ in a compound is a C₆-C₂₂ hydrocarbyl group, preferably having an IV from about 70 to about 140 based upon the IV of the equivalent fatty acid with the cis/trans ratio preferably being as described hereinafter, m is a number from 1 to 3 on the weight average in any mixture of compounds, each R in a compound is a C₁₋₃ alkyl or hydroxy alkyl group, the total of m and the number of R groups that are hydroxyethyl groups equaling 3, and X is a softener compatible anion, preferably methyl sulfate. Preferably the cis:trans isomer ratio of the fatty acid (of the Cl8:1 component) is at least about 1:1, preferably about 2:1, more preferably about 3:1, and even more preferably about 4:1, or higher.

A preferred biodegradable fabric softener compounds comprises quaternary ammonium salt, the quaternized ammonium salt being a quaternized product of condensation between:

a) a fraction of saturated or unsaturated, linear or branched fatty acids, or of derivatives of said acids, said fatty acids or derivatives each possessing a hydrocarbon chain in which the number of atoms is between 5 and 21, and

b) triethanolamine,

and is characterized in that said condensation product has an acid value, measured by titration of the condensation product with a standard KOH solution against a phenolphthalein indicator, of less than about 6.5. The acid value is preferably less than or equal to about 5, more preferably less than about 3. Indeed, the lower the AV, the better softness performance is obtained. The acid value is determined by titration of the condensation product with a standard KOH solution against a phenolphthalein indicator according to ISO#53402. The AV is expressed as mg KOH/g of the condensation product.

For optimum softness benefit, it is preferred that the reactants are present in a molar ratio of fatty acid fraction to triethanolamine of from about 1:1 to about 2.5:1. It has also been found that the optimum softness performance is also affected by the detergent carry-over laundry conditions, and more especially by the presence of the anionic surfactant in the solution in which the conditioning composition is used. Indeed, the presence of anionic surfactant that is usually carried over from the wash will interact with the softener compound, thereby reducing its performance. Thus, depending on usage conditions, the mole ratio of fatty acid/triethanolamine can be critical. Accordingly, where no rinse occurs between the wash cycle and the rinse cycle containing the softening compound, a high amount of anionic surfactant will be carried over in the rinse cycle containing the softening compound. In this instance, it has been found that a fatty acid fraction/triethanolamine mole ratio of about 1.4:1 to about 1.8:1 is preferred. By high amount of anionic surfactant, it is meant that the presence of anionic in the rinse cycle at a level such that the molar ratio anionic surfactant/cationic softener compound of the invention is at least about 1/10. Therefore, a method of treating fabrics comprises the step of contacting the fabrics in an aqueous medium containing the above softener compounds or conditioning compositions, wherein the fatty acid/triethanolamine mole ratio in the softener compound is from about 1.4:1 to about 1.8:1, preferably about 1.5:1, and the aqueous medium comprises a molar ratio of anionic surfactant to said softener compound of at least about 1:10.

When an intermediate rinse cycle occurs between the wash and the later rinse cycle, less anionic surfactant, i.e. less than about 1:10 of a molar ratio anionic surfactant to cationic compound of the invention, will then be carried over. Accordingly, it has been found that a fatty acid/triethanolamine mole ratio of about 1.8:1 to about 2.2:1 is then preferred. Under such lower anionic carryover conditions, a method of treating fabrics comprises the step of contacting the fabrics in an aqueous medium containing the softener compound or conditioning composition thereof wherein the fatty acid/triethanolamine mole ratio in the softener compound is from about 1.8:1 to about 2:1, preferably about 2.0:1, and most preferably about 1.9, and the aqueous medium comprises a molar ratio of anionic surfactant to said softener compound of less than about 1:10. In a preferred embodiment the fatty acid fraction and the triethanolamine are present in a molar ratio of from about 1:1 to about 2.5:1.

Preferred cationic, preferably biodegradable quaternary, ammonium fabric softening compounds can contain the group —(O)CR¹ which is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of fatty acids (FA) are listed in U.S. Pat. No. 5,759,990 at column 4, lines 45-66.

Mixtures of fatty acids, and mixtures of FAs that are derived from different fatty acids can be used, and are preferred. Nonlimiting examples of FA's that can be blended, to form FA's of this invention are as follows:

| Fatty Acyl Group | FA¹ | FA² | FA³ |
|---|---|---|---|
| C₁₄ | 0 | 0 | 1 |
| C₁₆ | 3 | 11 | 25 |
| C₁₈ | 3 | 4 | 20 |
| C14:1 | 0 | 0 | 0 |
| C16:1 | 1 | 1 | 0 |
| C18:1 | 79 | 27 | 45 |
| C18:2 | 13 | 50 | 6 |
| C18:3 | 1 | 7 | 0 |
| Unknowns | 0 | 0 | 3 |
| Total | 100 | 100 | 100 |
| IV | 99 | 125-138 | 56 |
| cis/trans (C18:1) | 5-6 | Not Available | 7 |
| TPU | 14 | 57 | 6 |

FA¹ is a partially hydrogenated fatty acid prepared from canola oil,
FA² is a fatty acid prepared from soy bean oil, and
FA³ is a slightly hydrogenated tallow fatty acid.

Preferred softener actives contain an effective amount of molecules containing two ester linked hydrophobic groups [R¹C(CO)O—], said actives being referred to hereinafter as “DEQA's”, are those that are prepared as a single DEQA from blends of all the different fatty acids that are represented (total fatty acid blend), rather than from blends of mixtures of separate finished DEQA's that are prepared from different portions of the total fatty acid blend.

It is preferred that at least a majority of the fatty acyl groups are unsaturated, e.g., from about 50% to 100%, preferably from about 55% to about 99%, more preferably from about 60% to about 98%, and that the total level of active containing polyunsaturated fatty acyl groups (TPU) be preferably from 0% to about 30%. The cis/trans ratio for the unsaturated fatty acyl groups is usually important, with the cis/trans ratio being from about 1:1 to about 50:1, the minimum being about 1:1, preferably at least about 3:1, and more preferably from about 4:1 to about 20:1. (As used herein, the “percent of softener active” containing a given R¹ group is the same as the percentage of that same R¹ group is to the total R¹ groups used to form all of the softener actives.)

The unsaturated, including the preferred polyunsaturated, fatty acyl and/or alkylene groups, discussed hereinbefore and hereinafter, surprisingly provide effective softening, but also provide better rewetting characteristics, good antistatic characteristics, and especially, superior recovery after freezing and thawing. The highly unsaturated materials are also easier to formulate into concentrated premixes that maintain a low viscosity for the neat product composition and are therefore easier to process, e.g., pump, mixing, etc. These highly unsaturated materials (total level of active containing polyunsaturated fatty acyl groups (TPU) being typically from about 3% to about 30%, with only the low amount of solvent that normally is associated with such materials, i.e., from about 5% to about 20%, preferably from about 8% to about 25%, more preferably from about 10% to about 20%, weight of the total softener/solvent mixture, are also easier to formulate into concentrated compositions, even at ambient temperatures. This ability to process the actives at low temperatures is especially important for the polyunsaturated groups, since it minimizes degradation. Additional protection against degradation can be provided when the compounds and conditioning compositions contain effective antioxidants, chelants, and/or reducing agents, as disclosed hereinafter.

It will be understood that substituents R and R¹ can optionally be substituted with various groups such as alkoxyl or hydroxyl groups, and can be straight, or branched so long as the R¹ groups maintain their basically hydrophobic character.

A preferred long chain DEQA is the DEQA prepared from sources containing high levels of polyunsaturation, i.e., N,N-di(acyl-oxyethyl)-N,N-methylhydroxyethylammonium methyl sulfate, where the acyl is derived from fatty acids containing sufficient polyunsaturation, e.g., mixtures of tallow fatty acids and soybean fatty acids. Another preferred long chain DEQA is the dioleyl (nominally) DEQA, i.e., DEQA in which N,N-di(oleoyl-oxyethyl)-N,N-methylhydroxyethylammonium methyl sulfate is the major ingredient. Preferred sources of fatty acids for such DEQAs are vegetable oils, and/or partially hydrogenated vegetable oils, with high contents of unsaturated, e.g., oleoyl groups.

As used herein, when the DEQA diester (m=2) is specified, it can include the monoester (m=1) and/or triester (m=3) that are present. Preferably, at least about 30% of the DEQA is in the diester form, and from 0% to about 30% can be DEQA monoester, e.g., there are three R groups and one R¹ group. For softening, under no/low detergent carry-over laundry conditions the percentage of monoester should be as low as possible, preferably no more than about 15%. However, under high, anionic detergent surfactant or detergent builder carry-over conditions, some monoester can be preferred. The overall ratios of diester “quaternary ammonium active” (quat) to monoester quat are from about 2.5:1 to about 1:1, preferably from about 2.3:1 to about 1.3:1. Under high detergent carry-over conditions, the di/monoester ratio is preferably about 1.3:1. The level of monoester present can be controlled in manufacturing the DEQA by varying the ratio of fatty acid, or fatty acyl source, to triethanolamine. The overall ratios of diester quat to triester quat are from about 10:1 to about 1.5:1, preferably from about 5:1 to about 2.8:1.

The above compounds can be prepared using standard reaction chemistry. In one synthesis of a di-ester variation of DTDMAC, triethanolamine of the formula N(CH₂CH₂OH)₃ is esterified, preferably at two hydroxyl groups, with an acid chloride of the formula R¹ C(O)Cl, to form an amine which can be made cationic by acidification (one R is H) to be one type of softener, or then quaternized with an alkyl halide, RX, to yield the desired reaction product (wherein R and R¹ are as defined hereinbefore). However, it will be appreciated by those skilled in the chemical arts that this reaction sequence allows a broad selection of agents to be prepared.

In preferred DEQA (1) and DEQA (2) softener actives, each R¹ is a hydrocarbyl, or substituted hydrocarbyl, group, preferably, alkyl, monounsaturated alkenyl, and polyunsaturated alkenyl groups, with the softener active containing polyunsaturated alkenyl groups being preferably at least about 3%, more preferably at least about 5%, more preferably at least about 10%, and even more preferably at least about 15%, by weight of the total softener active present; the actives preferably containing mixtures of R¹ groups, especially within the individual molecules.

The DEQAs herein can also contain a low level of fatty acid, which can be from unreacted starting material used to form the DEQA and/or as a by-product of any partial degradation (hydrolysis) of the softener active in the finished composition. It is preferred that the level of free fatty acid be low, preferably below about 15%, more preferably below about 10%, and even more preferably below about 5%, by weight of the softener active.

The fabric softener compounds herein are preferably prepared by a process wherein a chelant, preferably a diethylenetriaminepentaacetate (DTPA) and/or an ethylene diamine-N,N′-disuccinate (EDDS) is added to the process. Another acceptable chelant is tetrakis-(2-hydroxylpropyl) ethylenediamine (TPED). Also, preferably, antioxidants are added to the fatty acid immediately after distillation and/or fractionation and/or during the esterification reactions and/or post-added to the finished softener active. The resulting softener active has reduced discoloration and malodor associated therewith.

The total amount of added chelating agent is preferably within the range of from about 10 ppm to about 5,000 ppm, more preferably within the range of from about 100 ppm to about 2500 ppm by weight of the formed softener active. The source of triglyceride is preferably selected from the group consisting of animal fats, vegetable oils, partially hydrogenated vegetable oils, and mixtures thereof. More preferably, the vegetable oil or partially hydrogenated vegetable oil is selected from the group consisting of canola oil, partially hydrogenated canola oil, safflower oil, partially hydrogenated safflower oil, peanut oil, partially hydrogenated peanut oil, sunflower oil, partially hydrogenated sunflower oil, corn oil, partially hydrogenated corn oil, soybean oil, partially hydrogenated soybean oil, tall oil, partially hydrogenated tall oil, rice bran oil, partially hydrogenated rice bran oil, and mixtures thereof. Most preferably, the source of triglyceride is canola oil, partially hydrogenated canola oil, and mixtures thereof. The process can also include the step of adding from about 0.01% to about 2% by weight of the composition of an antioxidant compound to any or all of the steps in the processing of the triglyceride up to, and including, the formation of the fabric softener active.

The above processes produce a fabric softener active with reduced coloration and malodor.

The following polyquaternary ammonium compounds are disclosed by reference herein as suitable for use in this invention: European Patent Application EP 0,803,498, A1, Robert O. Keys and Floyd E. Friedli, filed Apr. 25, 1997; British Pat. 808,265, issued Jan. 28, 1956 to Arnold Hoffman & Co., Incorporated; British Pat. 1,161,552, Koebner and Potts, issued Aug. 13, 1969; DE 4,203,489 A1, Henkel, published Aug. 12, 1993; EP 0,221,855, Topfl, Heinz, and Jorg, issued Nov. 3, 1986; EP 0,503,155, Rewo, issued Dec. 20, 1991; EP 0,507,003, Rewo, issued Dec. 20, 1991; EPA 0,803,498, published Oct. 29, 1997, French Pat. 2,523,606, Marie-Helene Fraikin, Alan Dillarstone, and Marc Couterau, filed Mar. 22, 1983; Japanese Pat. 84-273918, Terumi Kawai and Hiroshi Kitamura, 1986; Japanese Pat. 2-011,545, issued to Kao Corp., Jan. 16, 1990; U.S. Pat. 3,079,436, Hwa, issued Feb. 26, 1963; U.S. Pat. No. 4,418,054, Green et al., issued Nov. 29, 1983; U.S. Pat. No. 4,721,512, Topfl, Abel, and Binz, issued Jan. 26, 1988; U.S. Pat. No. 4,728,337, Abel, Topfl, and Riehen, issued Mar. 1, 1988; U.S. Pat. No. 4,906,413, Topfl and Binz, issued Mar. 6, 1990; U.S. Pat. No. 5,194,667, Oxenrider et al., issued Mar. 16, 1993; U.S. Pat. No. 5,235,082, Hill and Snow, issued Aug. 10, 1993; U.S. Pat. No. 5,670,472, Keys, issued Sep. 23, 1997; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. All of these references are incorporated herein, in their entirety, by reference. The products formed by quaternization of reaction products of fatty acid with N,N,N′,N′, tetraakis(hydroxyethyl)-1,6-diaminohexane are also disclosed as suitable for this invention. Some nonlimiting structural examples produced by this reaction are given below:

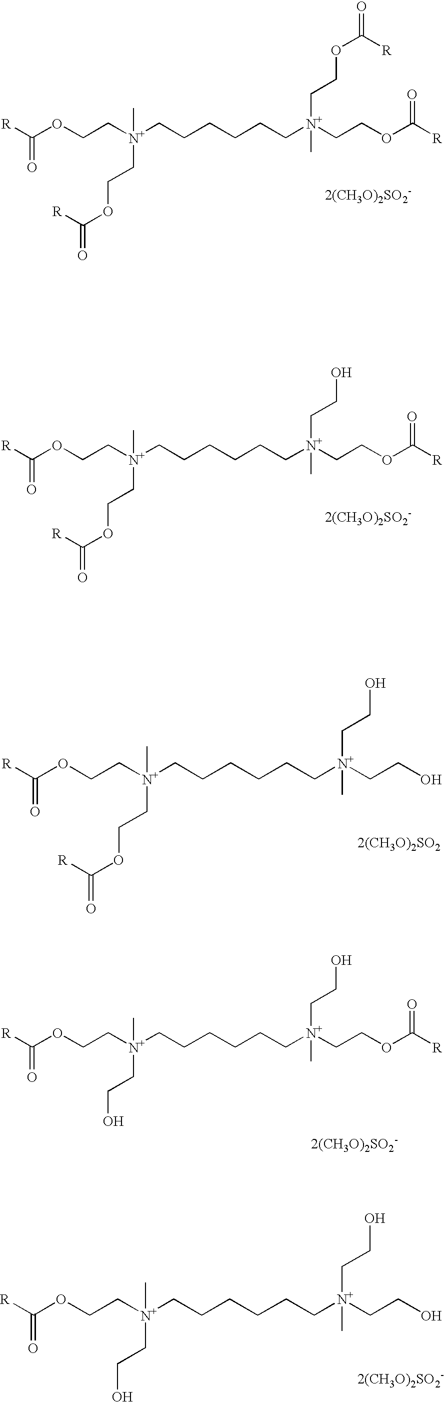

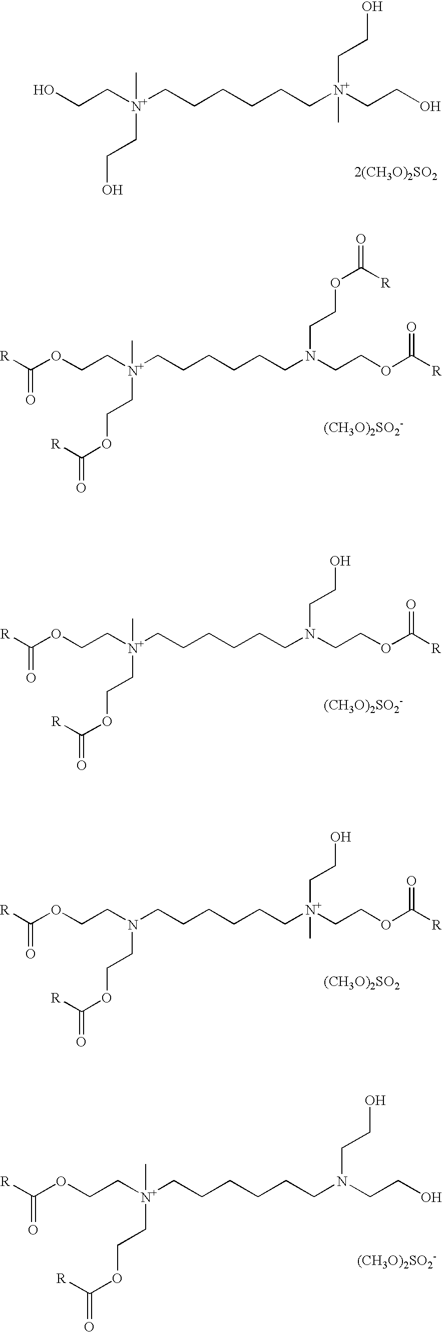

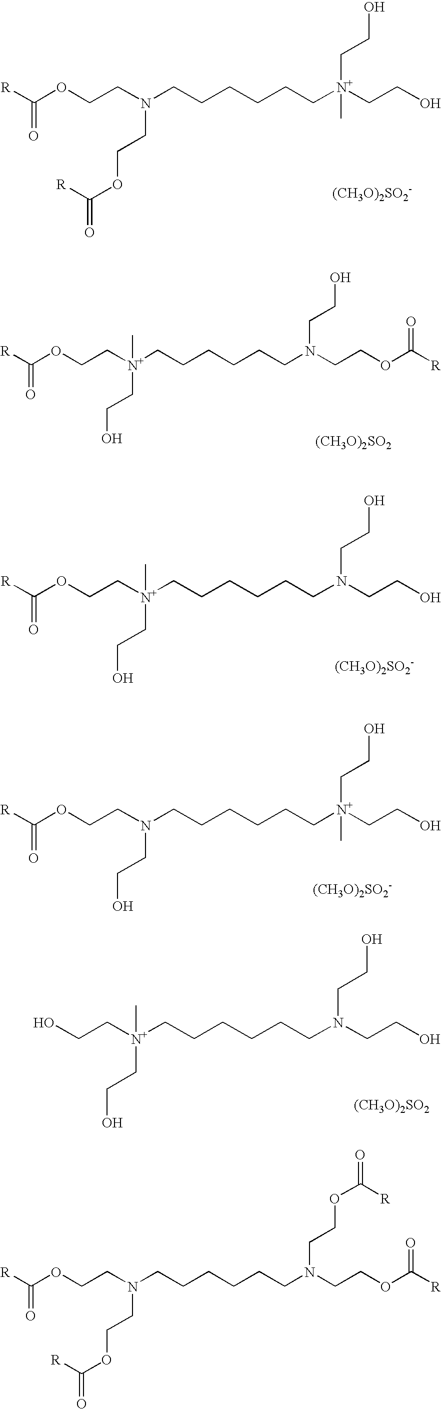

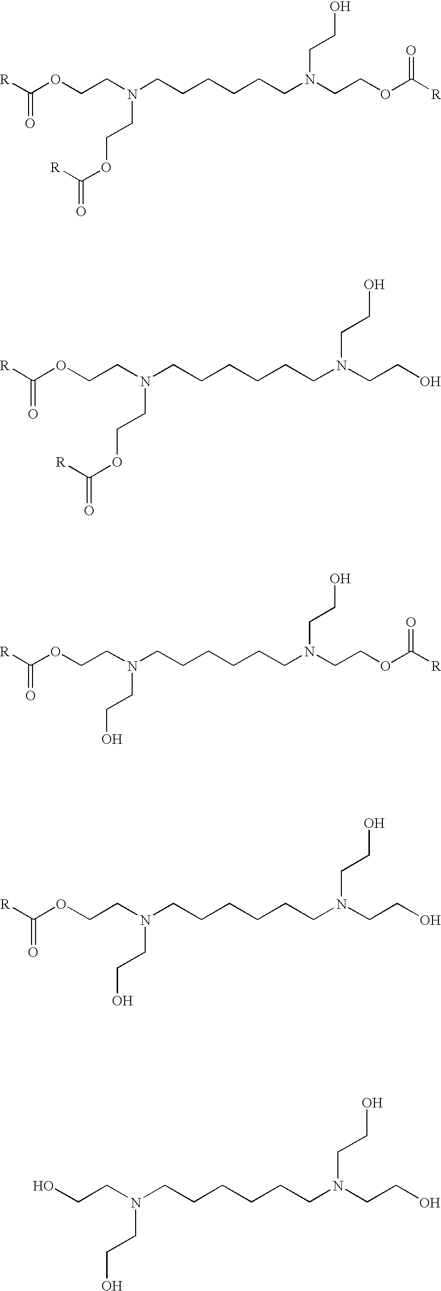

and R is defined as R¹ as described above.

Anion A

In the cationic nitrogenous salts herein, the anion A⁻, which is any softer compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

It will be understood that combinations of softener compounds disclosed above are suitable for use in the conditioning compositions of the present invention.

B. Appearance Enhancing Agent

The appearance enhancing agent of the compositions of the present invention are preferably selected from the group consisting of peroxygen bleaching agents, bluing agents and mixtures thereof. The specific amount of the appearance enhancing agent present in the liquid fabric conditioning composition will varying depending on their identity but should be present in at a quantity that is effective to improve the color and/or clarity of the rinse solution. An improvement in the color of the rinse solution will be recognized as a softening or lightening of the existing color or a change of the existing color. Improvements in the clarity of the rinse solution will be recognized as an alteration of the solution so that it is less opaque and potentially translucent.

1. Peroxygen Bleaching Agent

The appearance enhancing agents of the present invention can include a peroxygen bleaching agent. This peroxygen bleaching agent may comprise any conventional peroxygen bleaching agent as are known and described in the art.

The weight ratio of the fabric softening compound to the peroxygen bleaching agent in the compositions of the present invention is between about 6:1 and about 1:4. When the weight ratio of the fabric softening compound to the peroxygen bleaching agent is between 4:1 and 1:1, it is preferable that the peroxygen bleaching agent not comprise a perphthalic acid or derivative thereof. Furthermore, when the weight ratio of the fabric softening compound to the peroxygen bleaching agent is between 1:1.5 and 1:4, it is preferable that the composition comprises greater than 6% of the fabric softening compound. The fabric conditioning compositions of the present invention can comprise peroxygen bleaching agent between about 3% and about 20%, preferably between about 5% and about 15% by weight of the composition.

Examples of suitable peroxygen bleaches include hydrogen peroxide, sodium peroxide, the perborates, percarbonates, persulfates, persilicates, peroxy disulphates, perphosphates and the crystalline peroxyhydrates formed by reacting hydrogen peroxide with urea or an alkali metal carbonate. The peroxygen bleaching agent is preferably water-soluble. Suitable peroxygen bleaching agents are described in U.S. Pat. No. 4,273,661, issued Jun. 16, 1981 to Grey; U.S. Pat. No. 4,203,852 issued May 20, 1980 to Johnson et al.; and U.S. Pat. No. 5,077,119 issued Dec. 31, 1991 to Wraige, all of which are incorporated herein by reference. Hydrogen peroxide is the preferred peroxygen bleaching agent because of its reduced tendency to interfere with the stability and/or functionality of the fabric conditioning composition.

2. Bluing Agent

A second appearance enhancing agent is a bluing agent comprising a dye or pigment material. While it is recognized that the use of bluing agents in the formulation of fabric conditioning compositions is known, the use of such materials has been limited to low levels that will provide a desired color to the fabric conditioning composition itself. The inclusion of bluing agents in such compositions has not addressed the color or appearance of the rinse solution into which the composition is to be dispensed. Therefore, the fabric conditioning compositions of the present invention comprise a bluing agent at level between about 0.001% and about 0.1%, and preferably between about 0.004% and about 0.1% by weight of the fabric conditioning composition.

Bluing agents suitable for use in the fabric conditioning compositions of the present invention are characterized by their ability to provide color to the rinse solution, preferably a blue or green hue. The bluing agent should be a water-soluble dye or a water-insoluble pigment capable of dispersion in water. Examples of dyes and pigments which can be utilized in this invention are: Polar Brilliant Blue GAW 180 percent sold by Ciba-Geigy S. A., Basel, Switzerland (similar to C.I. [“Color Index”] 61135—Acid Blue 127); FD&C Blue No. 1 (C.I. 42090), Rhodamine BM (C.I. 45170); Pontacyl Light Yellow 36 (similar to C.I. 18820); Acid yellow 23; Pigmasol blue; Acid blue 3; Polar Brilliant Blue RAW (C.I. 61585—Acid Blue 80); Phthalocyanine Blue (C.I. 74160); Phthalocyanine Green (C.I. 74260); and Ultramarine Blue (C.I. 77007—Pigment Blue 29). Additional examples of suitable bluing agents are described in U.S. Pat. No. 3,931,037 issued Jan. 6, 1976 to Hall and U.S. Pat. No. 5,605,883 issued Feb. 25, 1997 to Iliffet al., said patents incorporated herein by reference.

Where the bluing agent is to be used in combination with a peroxygen bleaching agent such as hydrogen peroxide, preferably the bluing agent is selected so as to be stable in the presence of that peroxygen bleaching agent. The stability of a bluing agent for use in combination with a peroxygen bleaching agent may be determined by measuring the reduction in the reflectance of a composition containing the bluing agent after storage. A reduction in the measured level of reflectance of more than about 50% for a composition containing a given bluing agent is not acceptable and would be considered an unstable bluing agent.

Specifically, the reduction in reflectance may be determined by preparing a neat composition containing the peroxygen bleaching agent without bluing agent and diluting the neat composition to make a 10% solution. The reflectance of this composition is then measured using an Uvikon Spectrophotometer XL at the relevant wavelength in order to set a zero index value. The relevant wavelength will depend on the dye or pigment used in the bluing agent and will be known to those skilled in the art and in reference literature. For instance, 420 nm would be the relevant wavelength for obtaining the reflectance of a blue dye or pigment. Different wavelengths will be used depending on the specific bluing agent or combination of dyes or pigments used.

A second composition containing the selected bluing agent and the peroxygen bleaching agent is freshly prepared, diluted to a 10% solution and then measured to set a 100 index value. As the solution is freshly made the obtained reflectance at the relevant wavelength for the dye is maximum and is the 100 index value. The reflectance of the composition is then measured after storage at 50° C. for one month. By way of example, if the reflectance of the fresh composition without bluing agent is measured at 65% and the reflectance of the fresh composition with bluing agent is 95%, then bluing agents that give a composition having a reflectance of at least about 80% after storage are considered stable in the presence of the peroxygen bleaching agent.

Stable bluing agents include acid dyes and more preferably Acid Blue 80 or Pigmasol Blue 15 and the like.

3. Mixtures

The appearance enhancing agents of the present invention may preferably comprise mixtures or combinations of peroxygen bleaching agents and bluing agents.

C. Adjunct Ingredients

The liquid fabric conditioning compositions of the present invention can contain one or more optional or adjunct ingredients selected from the following.

1. Buffering System

Optionally, the compositions herein contain from 0% to about 5%, preferably from about 0.01% to about 2.5%, more preferably from about 0.1% to about 1% by weight of a buffering system. The buffering system comprises an acidifying agent with or without an alkaline agent, in amounts sufficient to provide a neat product having a pH within the range of 1.5 to 6. Typical buffering systems can comprise inorganic acids such as hydrochloric acid, organic acids such as citric and maleic acids, and alkaline components sodium hydroxide, sodium hydroxyl ethyl di-phosphonic acid, sodium carbonate, mono and polyhydrogenophosphonates.

2. Perfume

Optionally, the compositions herein contain from 0% to about 5%, preferably from about 0.01% to about 2.5%, more preferably from about 0.1% to about 1% by weight of a perfume, pro-fragrance, or mixture thereof. Perfumes and pro-fragrances suitable for use in the compositions of the present invention are described in detail in U.S. Pat. No. 6,093,691 issued Jul. 25, 2000 to Sivik et al. and U.S. Pat. No. 6,156,710 issued Dec. 5, 2000 to Sivik et al., both of said patents being incorporated herein by reference.

3. Non-Ionic Surfactant

Optionally, the compositions herein contain from 0% to about 5%, preferably from about 0.01% to about 2.5%, more preferably from about 0.1% to about 1% by weight of a non-ionic surfactant. Suitable nonionic surfactants include the addition products of ethylene oxide, and optionally propylene oxide, with fatty alcohols, fatty acids, fatty amines, etc. as well as the straight chain primary and secondary alcohol alkoxylates, alkyl phenol alkoxylates, olefinic alkoxylates and branched chain alkoxylates and mixtures of the same. Preferred nonionic surfactants comprise about 6 to about 14 carbons, more preferably about 9 to about 11 carbons, and further comprise about 3 to about 11 ethylene oxide groups and more preferably about 6 to about 10 ethylene oxide groups. Nonionic surfactants are described in U.S. Pat. No. 5,460,736 issued Oct. 24, 1995 to Trinh et al., which is incorporated herein by reference.

4. Silicone

The compositions of the present invention optionally comprise from about 0% to about 0.5%, preferably from about 0.01% to about 0.4%, more preferably from about 0.05% to about 0.2% by weight of the composition, of a silicone antifoam or suds suppression agent. The silicone materials can be alkylated polysiloxane materials of several types, either singly or in combination with various solid materials such as silica aerogels and xerogels and hydrophobic silicas of various types. In industrial practice, the term “silicone” has become a generic term that encompasses a variety of relatively high molecular weight polymers containing siloxane units and hydrocarbyl groups of various types. In general terms, suitable silicone suds suppressors can be described as siloxanes and more specifically, polydimethylsiloxanes having a molecular weight within the range of from about 200 to about 200,000, and higher. Preferably, these suds suppressors comprise emulsified linear polydimethylesiloxanes. Such silicone materials are commercially available from the Dow Corning under the trade name Silicone 200 Fluids™. Preferred silicone suds suppressors include aqueous emulsions available under the tradename DC-2210 and DC-2310 from Dow Corning. Other preferred antifoam materials are described in U.S. Pat. No. 4,652,392, issued Mar. 24, 1987 to Baginski et al., which is herein incorporated by reference in its entirety.

5. Electrolyte

Optionally, the compositions herein contain from 0% to about 10%, preferably from about 0.1% to about 5%, more preferably from about 0.1% to about 2% by weight of a water-soluble electrolyte. A wide variety of ionizable salts may be used as the electrolyte. Examples of suitable salts are the halides or sulphates of the Groups IA and IIA metals of the Periodic Table of the Elements, e.g., calcium chloride, magnesium chloride, sodium chloride, potassium bromide, calcium sulphate, magnesium sulphate and lithium chloride. The ionizable salts are particularly useful during the process of mixing the ingredients to make the compositions herein, and later to obtained the desired viscosity. The amount of ionizable salts used depends on the amount of the active ingredients used in the compositions and can be adjusted according to the desired of the formulator. Typical levels used to control composition viscosity are from about 20 to about 20,000 parts per million (ppm), preferably from about 20 to about 11,000 ppm, by weight of the composition.

6. Soil Release Polymer

Optionally, the compositions herein contain from 0% to about 10%, preferably from about 0.1% to about 5%, more preferably from about 0.1% to about 2% by weight of a soil release polymer. Particularly useful soil release polymers comprise copolymeric blocks of terephthalate and polyethylene oxide or polypropylene oxide and the like as are described in U.S. Pat. No. 4,956,447 issued Sep. 11, 1990 to Gosselink et al. and EP Patent Application EP 185,427 published Jun. 25, 1986, said patent and patent application being incorporated herein by reference.

7. Residue Reducing Agent

The fabric conditioning compositions of the present invention opitionally, but preferably comprise a residue reduction agent (“RRA”) present in the composition at a level of from about 0.05% to 10%, preferably from about 0.5% to about 8%, and more preferably from about 0.75% to about 5%, by weight of the composition.

A residue reduction agent is a material that will interact with surfactant residue and attract it away from the fabric surface and pull it into solution. The RRA is preferably tailored to the surfactant residue so as to include a “surfactant-attracting” portion which is attracted to the surfactant residue's ionic moieties, hydrophobic moieties, and/or alkoxylated moieties. Typically, the surfactant-attracting portion forms a non-covalent bond, such as an ion pair, with the surfactant residue. For example, in order to remove an anionic surfactant residue, a cationic RRA and/or a zwitterionic RRA may be useful herein, whereas to remove other types of surfactant residues, such as nonionic surfactant residues and cationic surfactant residues, a nonionic residue reduction agent and an anionic RRA may be respectively employed.

Furthermore, the hydrophobic and/or hydrophilic moieties on the RRA may be tailored to the specific surfactant residue targeted for removal, thereby improving overall surfactant residue removal. Thus, the RRA herein typically contains a surfactant-attracting portion selected from a hydrophobic moiety, a charged moiety, and a combination thereof, preferably a charged moiety and more preferably a cationic moiety. Since anionic surfactant residues cause the most concern for consumers, the RRA is preferably a cationic RRA and/or zwitterionic RRA. The cationic RRA and zwitterionic RRA useful herein typically have a quaternized nitrogen atom that is especially effective in forming an ion pair with an anionic surfactant residue.

The RRA useful herein typically contains one or more alkoxylated repeating groups along with “short” and “longer” alkyl groups, preferably with two alkoxylated repeating groups, one short chain alkyl group, and one long chain alkyl group attached to the quaternized nitrogen. The cationic RRA and/or zwitterionic RRA useful herein thus preferably has the formula:

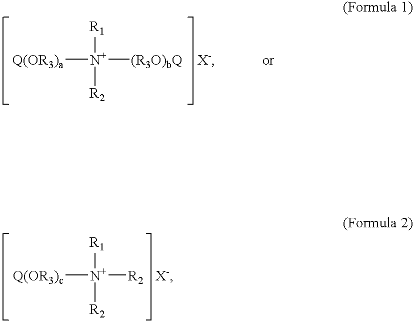

where R¹ is a saturated or unsaturated alkyl or aryl group having more than 4 carbon atoms, preferably more than about 10 carbon atoms, and more preferably from about 12 to about 25 carbon atoms. In addition, each R₂ is independently a C₁₋₄ alkyl group, preferably a C₁₋₂ alkyl group, and more preferably a methyl group, and each R₃ is independently a C₂₋₄ alkyl group preferably a C₂₋₃ alkyl group, and more preferably an ethyl group. In these formulas, a, b, and c denote average degrees of alkoxylation, and thus need not be integers. Thus, a and b are each independently from about 1 to about 20, preferably from about 3 to about 15, and more preferably from about 5 to about 10, while c is from about 1 to about 30, preferably from about 5 to about 20, and more preferably from about 10 to about 15.

Each Q is independently selected from H, SO₃⁻, C₁₋₄ alkyl, CO₂⁻, —(CH₂)_{d}PO₃M, —(CH₂)_{d}OPO₃M, —(CH₂)_{d}SO₃M, —CH₂CH(SO₃M)CH₂SO₃M, or —CH₂CH(SO₂M)CH₂SO₃M, where d is from about 1 to about 5, preferably from about 1 to about 3, and more preferably from about 1 to about 2, and where M is a cation providing charge neutrality or a mixture thereof, preferably M is a water-soluble alkali metal ion, an alkali earth metal ion, or a mixture thereof, and more preferably M is sodium ion, potassium ion, or a mixture thereof. Preferably, Q is selected from the group consisting of SO₃⁻, CO₂⁻, H, and a mixture thereof, and more preferably at least one Q is SO₃⁻. Finally, X⁻ denotes an anion or a mixture thereof, preferably a water-soluble halide anion, and more preferably chloride ion, as needed, for providing charge neutrality.

The cationic RRA and/or the zwitterionic RRA may also have a plurality, and more preferably from about 2 to about 6 cationic nitrogen moieties. Without intending to be limited by theory, it is believed that such multiple cationic moieties further strengthen the attachment of the RRA to an anionic surfactant. More preferably, the plurality of cationic nitrogen moieties are linked by a linker such as a straight or branched hydrocarbon backbone, preferably ethylene, propylene, isopropylene, hexamethylene, 1,4-dimethylenebenzene, and/or 4,9-dioxadodecylene.

The present cationic RRA is intended to wash away in the rinse, and drag the anionic surfactant residue away from the fabric. This is significantly different from, for example, a cationic fabric softening active, whose HLB is significantly lower (i.e., more hydrophobic), and whose benefits are proportional to the amount of fabric softening active deposited onto the fabric. Non-limiting, preferred examples of the RRA useful herein include PEG-15 cocomonium chloride (CAS #61791-10-4) available as ETHOQUAD-C25 monochloride, from Akzo-Nobel Chemicals, Inc., Chicago, Ill., U.S.A.; PEG-17 cocomonium chloride (CAS # 61791-10-4) available as Berol 556, from Akzo-Nobel Chemicals, Inc., Chicago, Ill., U.S.A.; PEG-10 palmityldimethylammonium chloride; and PEG-96 dicocoylhexamethyenediammonium chloride, available from BASF Chemicals, Ludwigshafen, Germany. In addition, non-limiting, preferred examples of the RRA useful herein include forms of all these materials in which 0-100% of the available terminal EO moieties have been sulfated. Mixtures of the above RRAs are also useful herein, especially a combination of a cationic RRA and a zwitterionic RRA.

8. Other Adjunct Materials and Mixtures

The liquid fabric conditioning compositions of the present invention may further comprise one or more other adjunct ingredients selected from the group consisting of enzymes, dye transfer inhibitors, chelants, chlorine scavengers, preservatives, surfactants, stabilizers, anti-shrinkage agents, fabric crisping agents, spotting agents, viscosity/dispersibility modifiers, germicides, fungicides, anti-oxidants such as butylated hydroxy toluene, anti-corrosion agents, and the like. The liquid fabric conditioning compositions of the present invention can also include other compatible ingredients, including those as disclosed in U.S. Pat. No. 5,460,736 issued Oct. 24, 1995 to Trinh et al.; U.S. Pat. No. 6,020,302 issued to Leurentop et al.; U.S. Patent No. 6,020,304, issued Feb. 1, 2000 to Ceulemans et al.; U.S. Pat. No. 6,083,899 issued Jul. 4, 2000 to Baker et al.; U.S. Pat. No. 6,134,712 issued Nov. 7, 2000 to Beckers et al., all of which are incorporated herein by reference.

Mixtures of two or more of the above described adjunct materials are also envisioned for use in the conditioning compositions of the present invention.

Examples

| | I | II | III | IV | V | VI |
|---|---|---|---|---|---|---|
| Softening agent¹ | 30 | 20 | 10 | 5 | 5 | 10 |
| Perfume | 1 | 1 | 0.5 | 1 | 1 | 0.5 |
| Buffering system² | 1 | 0.4 | 0.1 | 0.1 | 0.4 | 0.1 |
| Nonionic surfactant³ | 1 | 0 | 0 | 0 | 0 | 0 |
| Inorganic salts⁴ | 10 | 0.3 | 0 | 0 | 0.3 | 0 |
| Residue Reduction | 3 | 0 | 1 | 0 | 0 | 1 |
| agent⁵ | | | | | | |
| Silicone suds | 0 | 0.1 | 0 | 0.1 | 0 | 1 |
| suppressant⁶ | | | | | | |
| Dye⁷ | 0.004 | 0.004 | 0.004 | 0.004 | 0.004 | 0.004 |
| H₂O₂ | 0 | 0 | 0 | 0 | 0 | 0 |
| Water | Bal. | Bal. | Bal. | Bal. | Bal. | Bal. |
| | VII | VIII | IX | X | XI | XII |
| Softening agent¹ | 30 | 20 | 10 | 5 | 5 | 10 |
| Perfume | 1 | 1 | 0.5 | 1 | 1 | 0.5 |
| Acidifying agent⁸ | 1 | 0.4 | 0.1 | 0.1 | 0.4 | 0.1 |
| Nonionic surfactant³ | 1 | 0 | 0 | 0 | 0 | 0 |
| Inorganic salts⁴ | 10 | 0.3 | 0 | 0 | 0.3 | 0 |
| Residue Reduction | 3 | 0 | 1 | 0 | 0 | 1 |
| agent⁵ | | | | | | |
| Silicone suds | 0 | 0.1 | 0 | 0.1 | 0 | 1 |
| suppressant⁶ | | | | | | |
| Dye⁷ | 0.05-0.1 | 0.05-0.1 | 0.05-0.1 | 0.05-0.1 | 0.05-0.1 | 0.05-0.1 |
| H₂O₂ | 0 | 0 | 0 | 0 | 0 | 0 |
| Water | Bal. | Bal. | Bal. | Bal. | Bal. | Bal. |
| | XII | XIV | XV | XVI | XVII | XVIII |
| Softening agent¹ | 30 | 20 | 10 | 5 | 5 | 10 |
| Perfume | 1 | 1 | 0.5 | 1 | 1 | 0.5 |
| Buffering systems² | 1 | 0.4 | 0.1 | 0.1 | 0.4 | 0.1 |
| Nonionic surfactant³ | 1 | 0 | 0 | 0 | 0 | 0 |
| Inorganic salts⁴ | 10 | 0.3 | 0 | 0 | 0.3 | 0 |
| Residue Reduction | 3 | 0 | 1 | 0 | 0 | 1 |
| agent⁵ | | | | | | |
| Silicone suds | 0 | 0.1 | 0 | 0.1 | 0 | 1 |
| suppressant⁶ | | | | | | |
| Dye⁷ | 0.004 | 0.004 | 0.004 | 0.004 | 0.004 | 0.004 |
| H₂O₂ | 5 | 5 | 5 | 5 | 5 | 5 |
| Water | Bal. | Bal. | Bal. | Bal. | Bal. | Bal. |
| | XIX | XX | XXI | XXII | XXIII | XXIV |
| Softening agent¹ | 30 | 20 | 10 | 5 | 5 | 10 |
| Perfume | 1 | 1 | 0.5 | 1 | 1 | 0.5 |
| Acidifying agent⁸ | 1 | 0.4 | 0.1 | 0.1 | 0.4 | 0.1 |
| Nonionic surfactant³ | 1 | 0 | 0 | 0 | 0 | 0 |
| Inorganic salts⁴ | 10 | 0.3 | 0 | 0 | 0.3 | 0 |
| Residue Reduction | 3 | 0 | 1 | 0 | 0 | |
| agent⁵ | | | | | | |
| Silicone suds | 0 | 0.1 | 0 | 0.1 | 0 | 1 |
| suppressant⁶ | | | | | | |
| Dye⁷ | 0.05-0.1 | 0.05-0.1 | 0.05-0.1 | 0.05-0.1 | 0.05-0.1 | 0.05-0.1 |
| H₂O₂ | 5 | 5 | 5 | 5 | 5 | 5 |
| Water | Bal. | Bal. | Bal. | Bal. | Bal. | Bal. |
| | XXV | XXVI | XXVII | XXVIII | XXIX | XXX |
| Softening agent¹ | 30 | 20 | 10 | 5 | 5 | 10 |
| Perfume | 1 | 1 | 0.5 | 1 | 1 | 0.5 |
| Buffering system² | 1 | 0.4 | 0.1 | 0.1 | 0.4 | 0.1 |
| Nonionic surfactant³ | 1 | 0 | 0 | 0 | 0 | 0 |
| Inorganic salts⁴ | 10 | 0.3 | 0 | 00.3 | 0 | |
| Residue Reduction | 3 | 0 | 1 | 0 | 0 | 1 |
| agent⁵ | | | | | | |
| Silicone suds | 0 | 0.1 | 0 | 0.1 | 0 | 1 |
| suppressant⁶ | | | | | | |
| Dye⁷ | 0.004 | 0.004 | 0.004 | 0.004 | 0.004 | 0.004 |
| H₂O₂ | 15 | 15 | 15 | 15 | 15 | 15 |
| | XXXI | XXXII | XXXIII | XXXIV | XXXV | XXXVI |
| Softening agent¹ | 30 | 20 | 10 | 5 | 5 | 10 |
| Perfume | 1 | 1 | 0.5 | 1 | 1 | 0.5 |
| Acidifying agents⁸ | 1 | 0.4 | 0.1 | 0.1 | 0.4 | 0.1 |
| Nonionic | 1 | 0 | 0 | 0 | 0 | 0 |
| surfactant³ | | | | | | |
| Inorganic salts⁴ | 10 | 0.3 | 0 | 0 | 0.3 | 0 |
| Residue Reduction | 3 | 0 | 1 | 0 | 0 | 1 |
| agent⁵ | | | | | | |
| Silicone suds | 0 | 0.1 | 0 | 0.1 | 0 | 1 |
| suppressant⁶ | | | | | | |
| Dye⁷ | 0.05 | 0.05 | 0.05 | 0.05 | 0.05 | 0.05 |
| H₂O₂ | 15 | 15 | 15 | 15 | 15 | 15 |

¹Diethyl ester dimethyl ammonium chloride
²Citric acid
³Ethoxylated fatty alcohol,C9-11 with 6-10 EOs
⁴Magnesium chloride
⁵N, methyl N,N di(polyethoxyethyl), dodecyl ammonium chloride
⁶Wacker SE 39
⁷Acid blue 80.
⁸Hydrochloric acid.

II. Uses and Methods

The present invention further relates to the use of a peroxygen bleaching agent in a liquid rinse-added fabric conditioning composition to improve the color and/or clarity of the rinse solution into which the liquid fabric conditioning composition is dispensed. Similarly, the present invention relates to the use of a bluing agent in a liquid rinse-added fabric conditioning composition to improve the color and/or clarity of the rinse solution into which the liquid fabric conditioning composition is dispensed.

The present invention also provides methods for improving the color and/or clarity of a fabric rinse solution. The method comprises the steps of washing fabrics in an aqueous detergent solution, rinsing the fabrics in an aqueous rinse solution, and adding a liquid fabric conditioning composition of the present invention to the rinse solution. As described hereinabove, the liquid fabric conditioning composition comprises an effective amount of a appearance enhancing agent to improve the clarity and/or color of the rinse solution, the appearance enhancing agent selected from the group consisting of a peroxygen bleaching agent, a bluing agent, and mixtures thereof.

The uses and methods of the present invention are most preferred for improving the clarity and/or color of the rinse solution where the laundered fabrics are washed and/or rinsed by hand. The use of a fabric conditioning composition to soften fabrics that are laundered by hand tends to discolor the rinse solution and render it turbid or opaque. Although the fabric conditioning compositions are typically added in the final rinse after the fabrics have been rinsed by the consumer, such an appearance of the rinse solution can be taken as an indicator of the state of the rinse and the presence of residual detergent or soils, erroneously leading to additional rinsing of the fabrics. The use of the compositions of the present invention and methods incorporating the use of the compositions will lead the consumer to use appropriate levels of fabric conditioning compositions and to reduce the amount of rinsing that the consumer performs after the addition of such compositions.

III. Fabric Conditioning Product

A. Liquid Fabric Conditioning Composition

The fabric conditioning product of the present invention comprises a liquid fabric conditioning composition as described hereinabove.

B. Container

The fabric conditioning product of the present invention comprises a container or package for containing the liquid fabric conditioning composition. Containers and packages manufactured from various polymeric materials using thermoforming techniques are well known and commonly used to advantage to contain liquid fabric conditioning compositions. Descriptions of such containers and packages and various manufacturing techniques may be found in U.S. Pat. No. 4,917,269 issued Apr. 17, 1990 to Fuchs et al.; U.S. Pat. No. 4,989,757 issued Feb. 5, 1991 to Krall; U.S. Pat. No. 5,020,692, issued Jun. 4, 1991 to Darr; U.S. Pat. No. 6,032,829 to Mar. 7, 2000 to Geisinger et al.; U.S. Pat. No. 6,085,949 issued Jul. 11, 2000 to Zimny et al.; U.S. Pat. No. 6,123,231 issued Sep. 26, 2000 to Geisinger; and U.S. Pat. No. 6,209,762 issued Apr. 3, 2001 to Haffner et al.; all of said patents being incorporated herein by reference.

C. Instructions for Use

The fabric conditioning product of the present invention further comprises a set of instructions associated with the container that include an instruction to the consumer to use the liquid fabric conditioning composition to improve the color and/or clarity of the rinse solution. Fabric conditioning compositions are not known to improve the appearance of the rinse solution. Such an instruction is preferred when using a liquid conditioning composition, and even more preferred when washing and/or rinsing fabrics by hand.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid rinse added fabric conditioning composition comprising:
a fabric softening compound;
an appearance enhancing agent selected from the group consisting of a peroxygen bleaching agent, a bluing agent, and mixtures thereof; and
the balance adjunct ingredients.

2. The conditioning composition of claim 1, wherein the appearance enhancing agent is a peroxygen bleaching agent and the weight ratio of the fabric softening compound to the peroxygen bleaching agent is between about 6:1 and about 1:4, provided that when the ratio is between 4:1 and 1:1 the peroxygen bleaching agent is not a perphthalic acid or derivative thereof, and that when the ratio is between 1:1.5 and 1:4 the composition comprises greater than 6% of the fabric softening compound.

3. The composition of claim 1, wherein the fabric softening compound is a quaternary ammonium compound having a hydrocarbyl chain that is a C₁₂-C₂₂ and is unsaturated.

4. The composition of claim 1, wherein the fabric softening compound is a quaternary ammonium compound having a hydrocarbyl chain that is a C₁₂-C₂₂ and is interrupted by an ester group.

5. The composition of claim 1, wherein the fabric softening compound is a silicone compound selected from the group consisting of cationic silicone polymer having amine functionality, non-ionic silicone copolymers comprising a dimethicone component, and mixtures thereof.

6. The composition of claim 1, wherein the peroxygen bleaching agent comprises hydrogen peroxide.

7. The composition of claim 1, wherein the peroxygen bleaching agent is present in the fabric conditioning composition at a level less than about 15% by weight.

8. The composition of claim 1, wherein the bluing agent is stable in the presence of a peroxygen bleaching agent.

9. The composition of claim 1, wherein the bluing agent is present in the fabric conditioning composition at level between about 0.004% and about 0.1% by weight.

10. The composition of claim 1, wherein the adjunct ingredients are selected from the group consisting of an acidifying agent, alkaline agent, perfume, non-ionic surfactant, residue reducing agent, cationic charge booster, silicone, electrolyte, dye transfer inhibitor, chelant, and mixtures thereof.

11. A method for improving the color and/or clarity of a fabric rinse solution, the method comprising the steps of:
washing fabrics in an aqueous detergent solution;
rinsing the fabrics in an aqueous rinse solution; and
adding a liquid fabric conditioning composition according to claim I to the rinse solution.

12. The method according to claim 11, wherein the fabrics are rinsed by hand.

13. A fabric conditioning product, said product comprising:
a liquid fabric conditioning composition according to claim 1;
a container for the composition; and
a set of instructions associated with the container, said set of instructions comprising an instruction to a consumer to use the fabric conditioning composition to improve the color and/or clarity of the rinse solution.

14. The product of claim 13, wherein said set of instructions comprises an instruction to an consumer to use the fabric conditioning composition when rinsing fabrics by hand.
